(19) United States
(12) Patent Application Publication
(10) Pub. No.: US 2013/0146754 A1
(43) Pub. Date: Jun. 13, 2013

(54) IMAGING SYSTEM USING OPTICAL FIBER ARRAY INTEGRATED WITH LENSES

(71) Applicant: Korea Basic Science Institute, Daejeon (KR)

(72) Inventors: Ki Soo Chang, Daejeon (KR); Seon Young Ryu, Chungcheongbuk-do (KR); Sun Cheol Yang, Daejeon (KR); Geon Hee Kim, Daejeon (KR); Hae Young Choi, Chungcheongbuk-do (KR)

(73) Assignee: KOREA BASIC SCIENCE INSTITUTE, Daejeon (KR)

(21) Appl. No.: 13/708,388

(22) Filed: Dec. 7, 2012

(30) Foreign Application Priority Data
Dec. 12, 2011 (KR) 10-2011-0132645

(51) Int. Cl. G01J 1/42; G01J 1/04

(52) U.S. Cl. CPC G01J 1/42; G01J 1/0488
USPC 250/227.23; 250/227.11

(57) ABSTRACT

Provided is an imaging system using an optical fiber array probe integrated with lenses for emitting light transmitted from a light source to a sample, and guiding light generated from the sample. The imaging system includes an optical fiber array probe integrated with lenses including an optical fiber lens with a lens surface of a predetermined radius of curvature in which one ends of two optical fibers are integrally connected with each other by heating a predetermined region including the one ends of the two optical fibers using a heating means. Therefore, a compact imaging system may be realized while effectively improving optical coupling efficiency through a simple manufacturing process.

### CROSS-REFERENCE TO RELATED APPLICATION

This application claims priority to and the benefit of Korean Patent Application No. 2011-0132645, filed on Dec. 12, 2011, the disclosure of which is incorporated herein by reference in its entirety.

### BACKGROUND

1. Field of the Invention

The present invention relates to an imaging system using an optical fiber array probe integrated with lenses, and more particularly, to a compact imaging system which may have higher optical efficiency compared to the related art using an optical fiber array probe in which optical fiber lenses are integrally formed at one ends of two strands of optical fiber arrays.

2. Discussion of Related Art

An optical fiber lens has been widely used in an imaging system using an optical fiber or a laser medical device using a laser.

In an imaging system, for example, a fluorescence spectroscopy system, a fluorescence imaging system, or a nonlinear imaging system, the simplest method of manufacturing a sample arm probe is to simultaneously transmit an excitation beam, fluorescence signals, or nonlinear signals using a single strand of optical fiber.

FIG. 1 is a schematic diagram showing an imaging system using a single strand of optical fiber. In such a structure, in order to separate excitation light and fluorescence signals or nonlinear signals generated from a sample to be transmitted and received, an optical splitter in a bulk form and lenses are needed, and this may cause difficulty in optical alignment when configuring the imaging system and complexity of the imaging system.

In order to solve these problems, optical fiber probes with a variety of structures have been developed. In the case of the fluorescence spectroscopy system, a method of separately using an optical fiber for transmission of excitation beams and detection of fluorescent beams has been proposed. In the methods proposed in the related art, ends of two strands of optical fiber attached side-by-side to each other are used which are simply cut or polished at a predetermined angle.

However, in the case of cutting and using the end of the optical fiber, the manufacture of the optical fiber probe is simple, but the optical fiber is available only in a sample having significantly strong fluorescence signals due to significantly low coupling efficiency of fluorescence signals generated in the sample. In addition, in the case of polishing the end of the optical fiber at the predetermined angle, while improvement in the coupling efficiency of approximately 2 times may be achieved compared to the case of cutting and using the end of the optical fiber, two optical fibers have to be cut at an accurate angle, and therefore the manufacturing process becomes complex.

As another method, a fluorescence endoscope system which includes a bulk ball lens formed at ends of several strands of optical fibers, thereby being depth-resolved while improving detection efficiency of fluorescence signals has been proposed.

In this method, the micro-sized ball lens is used to reduce a size of a probe, and therefore optical alignment between several strands of optical fibers and the ball lens is very difficult. In addition, even though the micro-sized ball lens is used, the size of the probe is increased compared to when only using the optical fiber, and accurate packaging is required.

In the case of a nonlinear microscope system, in order to reduce difficulty in optical alignment and complexity of the system, a nonlinear microscope system of an endoscope type using an optical fiber element and a micro lens has been proposed. For example, an example has been disclosed in H. Bao et al., Optics Letters, 35(7), 995, 2019. According to this paper, the difficulty in optical alignment has been overcome by replacing existing bulk optical elements using a special optical fiber coupler using a double-clad optical fiber, and a compact nonlinear microscope system may be realized by attaching a scanning system to the end of the probe.

However, the manufacture of an optical element such as a coupler is still required, and a complex process of manufacturing the probe such as attaching several pieces of bulk lens is required.

### SUMMARY OF THE INVENTION

The present invention is directed to an optical fiber array probe integrated with lenses, which may realize its miniaturization while improving optical coupling efficiency, and an imaging system using the optical fiber array probe integrated with lenses.

The present invention is also directed to an imaging system using an optical fiber array probe integrated with lenses, in which optical fiber lenses are integrally formed at one ends of two strands of optical fiber arrays using a heating means, thereby solving problems such as lower optical coupling efficiency of the existing optical fiber array probes, complexity of a structure, difficulties in optical alignment and packaging, the need of a special optical element, and difficulty in the manufacturing process.

According to an aspect of the present invention, there is provided an imaging system using an optical fiber array probe integrated with lenses, the imaging system including: an optical fiber array probe integrated with lenses including an optical fiber lens with a lens surface of a predetermined radius of curvature in which one ends of two optical fibers are integrally connected with each other by heating a predetermined region including the one ends of the two optical fibers using a heating means, as an optical fiber array probe integrated lens for emitting light transmitted from a light source to a sample and guiding light generated from the sample, and capable of being scanned at least in one direction; and a detector selectively detecting light transmitted from the optical fiber array probe integrated with lenses as signals of a predetermined region.

Preferably, the detector may include a filter for allowing a wavelength to be selectively passed.

In addition, a system control and display unit for controlling the system and visualizing the detected light may be connected to the detector.

In addition, the optical fiber array probe integrated with lenses may be configured so as to be scanned two-dimensionally or three-dimensionally.

In addition, the imaging system may be able to be manufactured as a system for analyzing fluorescence spectroscopy images or nonlinear images.

In addition, in the imaging system, the lens of the optical fiber array probe may be integrally formed to thereby have a working distance of the lens, and therefore the probe capable of being scanned may be manufactured, and a fluorescence imaging system or a nonlinear imaging system may be implemented using the probe.

According to another aspect of the present invention, there is provided an imaging system using an optical fiber array probe integrated with lenses, the imaging system including: an optical fiber array probe integrated with lenses including an optical fiber lens with a lens surface of a predetermined radius of curvature in which one ends of two optical fibers are integrally connected with each other by heating a predetermined region including the one ends of the two optical fibers using a heating means, as an optical fiber array probe integrated lens for emitting light transmitted from a light source to a sample and guiding light generated from the sample; and a detector selectively detecting light transmitted from the optical fiber array probe integrated with lenses in a wavelength of a predetermined region, wherein the optical fiber array probe integrated with lenses is inserted into a syringe.

In addition, the optical fiber array probe integrated with lenses may be configured so as to be scanned two-dimensionally or three-dimensionally, or may be configured in a point detection method without scanning.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a schematic diagram showing an imaging system according to the related art;

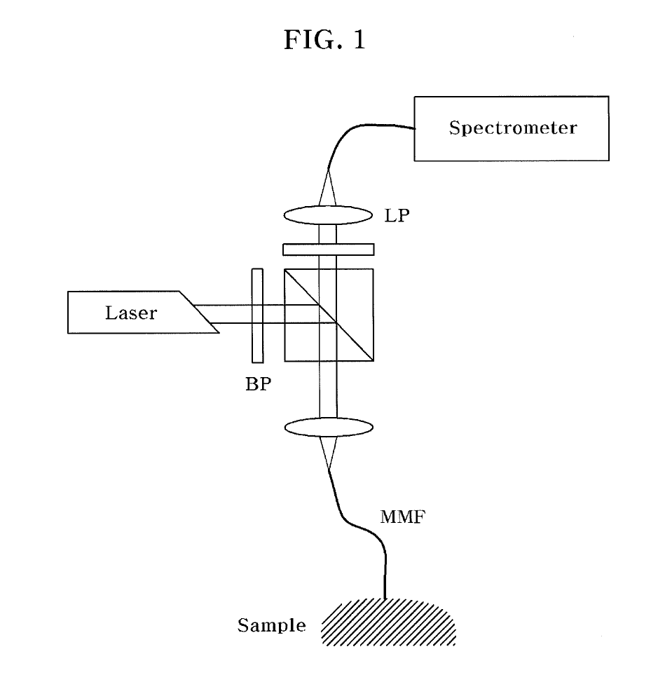

FIG. 2 is a block diagram showing an imaging system using an optical fiber array probe integrated with lenses according to a first embodiment of the present invention;

FIG. 3 is a drawing showing an optical fiber array probe that is used in the imaging system using the optical fiber array probe integrated with lenses of FIG. 2;

FIG. 4 is a schematic diagram showing a method of manufacturing an optical fiber array probe that is used in the imaging system using the optical fiber array probe integrated with lenses of FIG. 2;

FIG. 5 is a block diagram showing an imaging system using an optical fiber array probe integrated with lenses according to a second embodiment of the present invention; and

FIG. 6 is a block diagram showing an imaging system using an optical fiber array probe integrated with lenses according to a third embodiment of the present invention.

### DETAILED DESCRIPTION OF EXEMPLARY EMBODIMENTS

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims. Elements of the example embodiments are consistently denoted by the same reference numerals throughout the drawings and detailed description.

It will be understood that, although the terms first, second, A, B, etc. may be used herein in reference to elements of the invention, such elements should not be construed as limited by these terms. For example, a first element could be termed a second element, and a second element could be termed a first element, without departing from the scope of the present invention. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.).

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

Hereinafter, a preferable embodiment of the present invention will be described referring to accompanying drawings in detail. Throughout the accompanying drawings, the same reference numerals are used to designate the same or similar components, and redundant descriptions thereof are omitted.

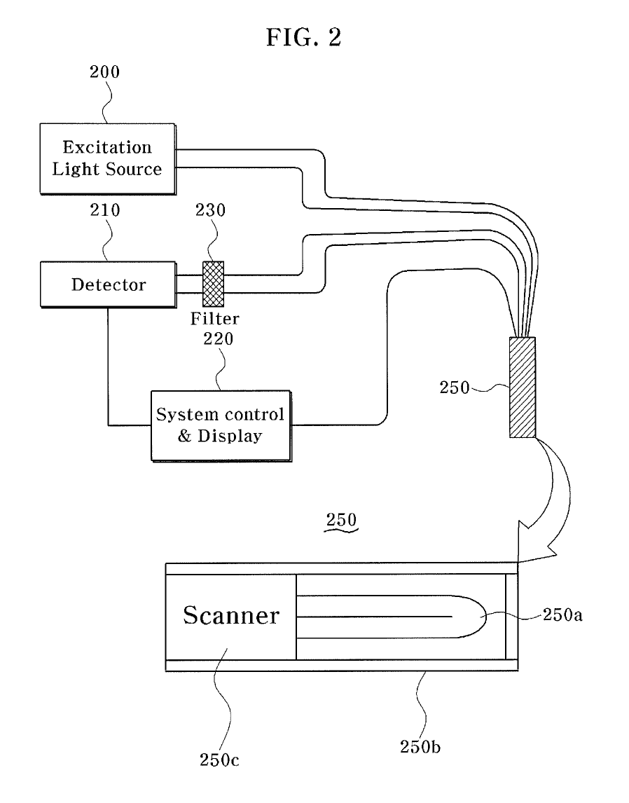

FIG. 2 is a block diagram showing an imaging system using an optical fiber array probe integrated with lenses according to a first embodiment of the present invention.

Referring to FIG. 2, the imaging system using the optical fiber array probe integrated with lenses according to an embodiment of the present invention mainly includes an optical fiber array probe 250 integrated with lenses and a detector 210, and further includes a light source 200 and a system control and display unit 220. The imaging system may be manufactured as a fluorescence spectroscopy system, a fluorescence imaging system, or a nonlinear imaging system.

The optical fiber array probe 250 integrated with lenses is a scanning probe on which light transmitted from the light source 200 is incident and which guides light reflected from a sample. As to a detailed structure of the optical fiber array probe 250 integrated with lenses, the optical fiber array probe 250 integrated with lenses includes an optical fiber probe array, and optical fiber lenses with a lens surface of a predetermined radius of curvature in which one ends of two optical fibers are integrally connected with each other by heating a predetermined region including the one ends of the two optical fibers using a heating means.

In an excitation light source and the detector of the imaging system, it is advantageous for a fluorescence spectroscopy system, a fluorescence imaging system, and a nonlinear endoscope system to be applied separately.

As the light source 200 of the fluorescence spectroscopy system, ultraviolet or visible light laser which has a single wavelength may be used. As examples of the ultraviolet or visible light laser, a He—Ne laser, an argon-ion laser, a DPSS laser, a dye laser, a tungsten-halogen laser including a filter, a xenon lamp, LED, and the like may be given. As a detector for the fluorescence spectroscopy system, a spectrometer is used, and in this instance, a long pass filter is used in order to measure only fluorescence signals emitted in a long wavelength compared to the excitation beam.

In addition, in the fluorescence imaging system, a light source such as a fluorescence spectroscopy system may be used, and a detector such as a long pass filter, a spectrometer, or photomultiplier tubes (PMTs) may be used as the detector 210.

As the light source 200 for the nonlinear endoscope system, a light source with strong optical power for inducing nonlinear signals is required. As the light source, a solid laser such as a femtosecond Ti:sapphire laser or a Cr:forsterite laser, or an optical fiber femtosecond laser may be used. As the detector 210, a PMT including a band pass filter may be used in order to selectively detect light transmitted from the optical fiber array probe 250 integrated with lenses in a wavelength of a predetermined region or to detect only nonlinear signals. The excitation beam has to be strongly focused in order to detect the nonlinear signals, and therefore it is preferable that, when manufacturing the probe for a nonlinear microscope, a curvature of the lenses is increased (larger number (NA) of apertures) compared to the fluorescence spectroscopy imaging system.

An excitation beam is transmitted to an excitation fiber of the optical fiber array probe 250 integrated with lenses to thereby be focused on a sample by a lens of the end of the probe, and signals generated by the focused excitation beam are repeatedly focused on the lens to thereby be transmitted to a collection fiber. Here, the transmitted signals are passed through the filter 230, and then only desired signals (desired wavelength or nonlinear signal) are detected through the detector.

In this instance, the system control and display unit 220 simultaneously controls a scanner and a detector of a scanning probe, and performs a signal process on the detected signals to thereby visualize the signals. By scanning the optical fiber array probe 250 integrated with lenses, it is possible to perform optical imaging two-dimensionally or three-dimensionally. According to another modified example of the present invention, the optical fiber array probe may not be scanned. Through this method, only point information rather than two-dimensional or three-dimensional information may be obtained.

As an example for directly driving the optical fiber array probe 250 integrated with lenses along an X axis or a Y axis, a piezoelectric translator (PZT) actuator, a micro electro mechanical system (MEMS) scanner, or a scanning method using electromagnetic force of a solenoid may be given. By driving a linear scanner in a Z-axis direction in such an XY-scanner, it is possible to perform three-dimensional imaging.

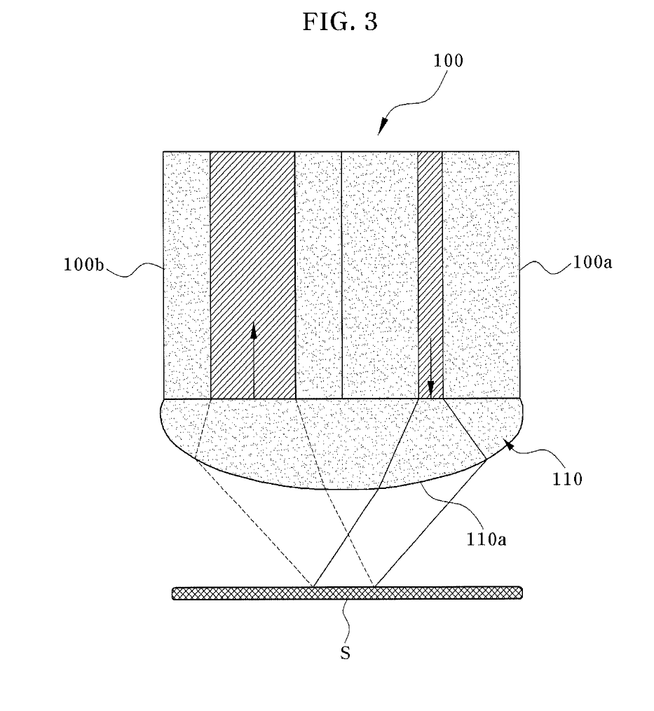

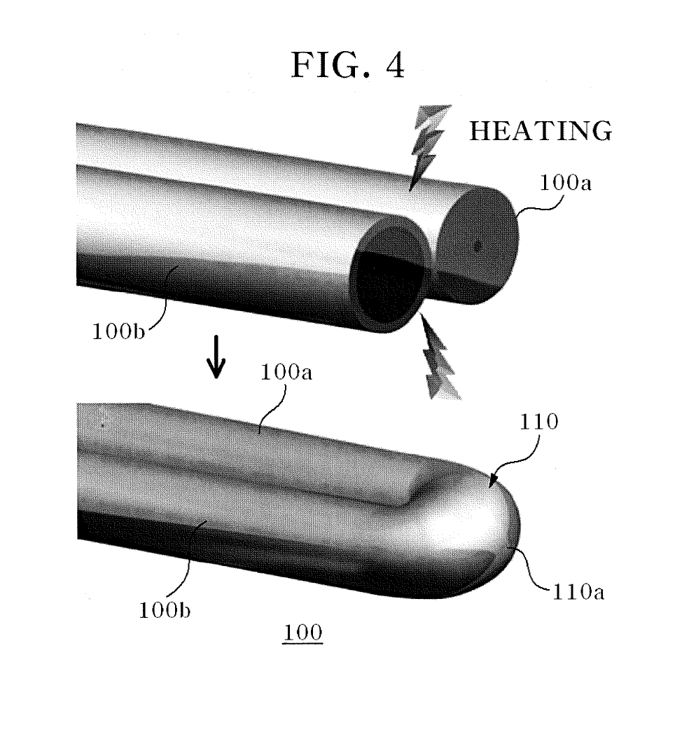

Hereinafter, the optical fiber array probes 250a and 100 of FIG. 2 will be described in detail. FIG. 3 is a drawing showing an optical fiber array probe that is used in the imaging system using the optical fiber array probe integrated with lenses, and FIG. 4 is a schematic diagram showing a method of manufacturing an optical fiber array probe.

The optical fiber array probe 250a includes first and second optical fibers 100a and 100b and an optical fiber lens 110. It is preferable that the first and second optical fibers 100a and 100b be arranged in parallel to each other, and one side surfaces of the first and second optical fibers 100a and 100b be arranged so as to be brought into linear contact or surface contact with each other. The first optical fiber 100a is composed of a single mode fiber (SMF) for an excitation beam, and the second optical fiber 100b is composed of a multi mode fiber (MMF) so as to receive a reflected beam (a collection beam). Here, the SMF is used for the excitation beam to reduce a size of a beam in a focal point, and the MMF is used for condensing to receive many beams due to a large core of the MMF. However, the optical fiber array probe may be manufactured using optical fibers with a variety of types and sizes other than the above-described configuration shown as an example.

The first and second optical fibers 100a and 100b may have the same or different structures, and for example, may include at least one of an SMF, an MMF, a photonic crystal fiber (PCF), and a double-cladding optical fiber.

For example, the photonic crystal fiber has a plurality of air holes around a core unlike a general SMF, and is referred to as a holey fiber or a microstructured fiber. Such a photonic crystal fiber includes a plurality of air holes (for example, 2 to 1000 air holes) regularly or irregularly arranged along a cladding of the optical fiber, and may be an optical fiber in which there are no air holes in a core of the optical fiber, or an optical fiber in which there are air holes in the core of the optical fiber, but the size thereof is different from that of air holes surrounding the core of the optical fiber.

The optical fiber lenses 110 are formed so as to be integrally connected with each other at one ends of the first and second optical fibers 100a and 100b, and include a lens surface 110a having a predetermined radius of curvature at the ends thereof.

The optical fiber lens 110 is formed so that light wave-guided along the core of the first optical fiber 100a is expanded so as to have a sufficient size on a lens surface 110a, and the expanded light is refracted on the lens surface 110a to thereby be formed toward a center of the entire optical fiber array probe. In addition, the optical fiber lens 110 refracts a beam emitted from a sample (S) on the lens surface 110a to thereby be formed towards the second optical fiber 100b.

The optical fiber lens 110 configured as above may be integrally formed at one ends of the first and second optical fibers 100a and 100b using a method of heating at a high temperature using arc-discharge, a laser, or the like.

An operation principle of the optical fiber array probe 100 integrated with lenses according to an embodiment of the present invention which has been described as above will be herein described. Light generated in an external light source unit is transmitted through a core of the first optical fiber 100a that is an SW, the beam transmitted through the core of the first optical fiber 100a is expanded in the optical fiber lens 110, and the expanded beam is refracted on the lens surface 110a formed at the end of the optical fiber lens 110 to thereby be oriented to a center of the entire optical fiber array probe. In this instance, the beam generated from the sample (S) is transmitted through a core of the second optical fiber 110b that is an MMF, using the optical fiber lens 110.

Meanwhile, according to an embodiment of the present invention, the optical fiber array probe is implemented using two strands of first and second optical fibers 100a and 100b, but the present invention is not limited thereto. For example, at least two strands of optical fibers which are brought into contact with each other may be implemented.

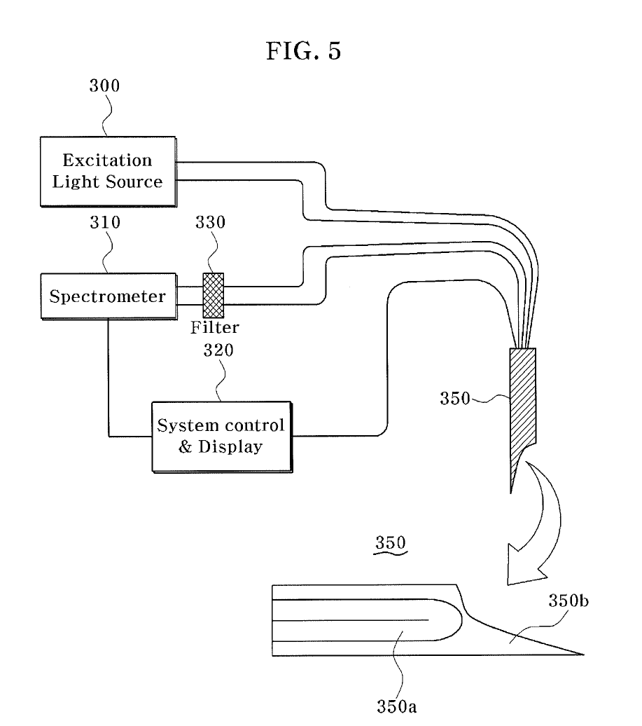

FIG. 5 is a block diagram showing an imaging system using an optical fiber array probe integrated with lenses according to a second embodiment of the present invention. For convenience of description, differences between the first and second embodiments will be described.

Referring to FIG. 5, the imaging system using the optical fiber array probe integrated with lenses according to an embodiment of the present invention mainly includes a scanning probe 350 and a detector 310, and further includes a light source 300 and a system control and display unit 320.

The imaging system uses the optical fiber array probe 350 integrated with lenses on which light transmitted from the light source 300 is incident and which guides light reflected in a sample, and has a structure in which an optical fiber probe array 350a is inserted inside a syringe 350b. In the structure in which two strands of optical fibers are coupled, a thickness of the optical fiber may be controlled to be within 500 μm to 2000 μm depending on a type of the optical fiber. Accordingly, the optical fiber array probe which is inserted into the syringe having an inner diameter of 500 μm to 2000 μm may be packaged.

In this structure, the imaging system may detect only one point without scanning the probe 350a, and may measure signals generated from one point inside a sample. Using the imaging system, the probe may be inserted up to a deeper position inside skin or tissue using the syringe, and therefore it is possible to measure and analyze fluorescence spectroscopy signals or nonlinear signals in deeper positions, thus overcoming limitations of light penetration.

According to the present embodiment, by adopting a relatively simple structure in which the optical fiber probe array 350a is inserted into the syringe 350b, a low cost and easy use may be realized.

The excitation light source, the wavelength filter, and the system control and display unit are the same as those of the first embodiment, and thus detailed descriptions thereof will be omitted.

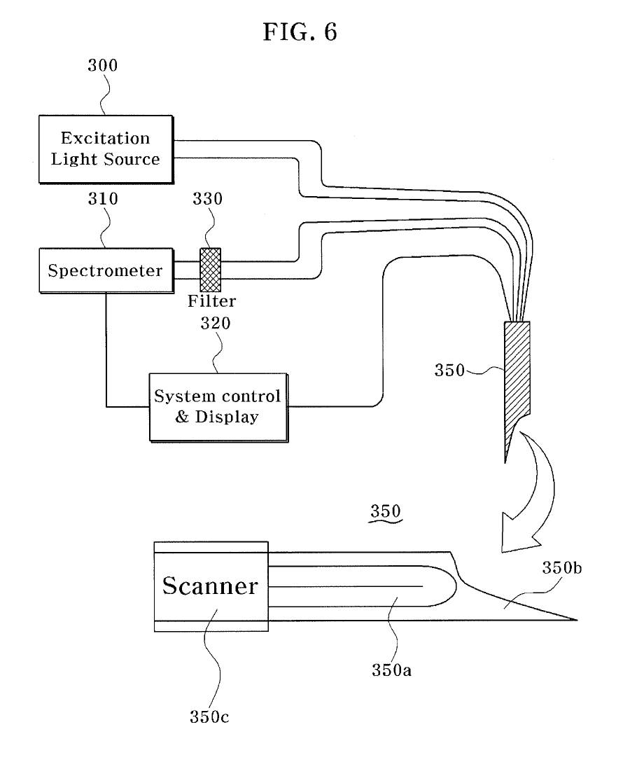

FIG. 6 is a block diagram showing an imaging system using an optical fiber array probe integrated with lenses according to a third embodiment of the present invention. For convenience of description, differences between the third embodiment and the first and second embodiments will be described.

In the imaging system using the optical fiber array probe integrated with lenses according to the third embodiment of the present invention, the optical fiber array probe 350 integrated with lenses may be configured so as to be scanned. As described above, for allowing scanning along an X axis or a Y axis, a piezoelectric translator (PZT) actuator, a micro electro mechanical system (MEMS) scanner, or a scanning method using electromagnetic force of a solenoid may be used. By driving a linear scanner in a Z-axis direction in such an XY-scanner, it is possible to perform three-dimensional imaging.

Using the imaging system according to the embodiments of the present invention, the probe may be inserted up to a deeper position inside skin or tissue using the syringe, and therefore it is possible to perform fluorescence spectroscopy imaging or nonlinear imaging in deeper positions, thus overcoming limitations of light penetration.

As described above, the imaging system using the optical fiber array probe integrated with lenses according to the embodiments of the present invention has the following advantages.

First, strong optical coupling efficiency may be obtained in a focal point, thereby improving signal measurement efficiency.

Second, a curvature of the lens may be controlled, and therefore the optical fiber array probe integrated with lenses may be utilized as a depth-resolved fluorescence probe for measuring fluorescence signals in a specific depth or a probe for detecting nonlinear signals requiring strong focusing of an excitation beam.

Third, the lenses may be directly formed at the ends of the optical fibers, thereby having a significantly compact size.

Fourth, a working distance may be obtained due to the lenses, and therefore the probe capable of being scanned may be manufactured, and a fluorescence imaging system or a nonlinear imaging system may be implemented using the probe.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. An imaging system using an optical fiber array probe integrated with lenses, the imaging system comprising:
an optical fiber array probe integrated with lenses including optical fiber lenses with a lens surface of a predetermined radius of curvature in which one ends of two optical fibers are integrally connected with each other by heating a predetermined region including the one ends of the two optical fibers using a heating means, as an optical fiber array probe integrated lens for emitting light transmitted from a light source to a sample and guiding light generated from the sample, and capable of being scanned at least in one direction; and
a detector selectively detecting light transmitted from the optical fiber array probe integrated with lenses as signals of a predetermined region.

2. The imaging system of claim 1, wherein the detector includes a filter for allowing a wavelength to be selectively passed.

3. The imaging system of claim 1, wherein a system control and display unit for controlling the system and visualizing the detected light is connected to the detector.

4. The imaging system of claim 1, wherein the optical fiber array probe integrated with lenses is configured so as to be scanned two-dimensionally or three-dimensionally.

5. The imaging system of claim 1, wherein the imaging system is able to be manufactured as a system for analyzing fluorescence spectroscopy images or nonlinear images.

6. An imaging system using an optical fiber array probe integrated with lenses, the imaging system comprising:
an optical fiber array probe integrated with lenses including optical fiber lenses with a lens surface of a predetermined radius of curvature in which one ends of two optical fibers are integrally with each other by heating a predetermined region including the one ends of the two optical fibers using a heating means, as an optical fiber array probe integrated lens for emitting light transmitted from a light source to a sample and guiding light generated from the sample; and
a detector selectively detecting light transmitted from the optical fiber array probe integrated with lenses in a wavelength of a predetermined region,
wherein the optical fiber array probe integrated with lenses is inserted into a syringe.

7. The imaging system of claim 6, wherein the optical fiber array probe integrated with lenses is configured so as to be scanned two-dimensionally or three-dimensionally.

8. The imaging system of claim 6, wherein the imaging system is able to be manufactured as a system for analyzing fluorescence spectroscopy images or nonlinear images.
